SEQUENCE LISTING (10 sequences)

SEQ ID NO: 1 - DNA, 475 bp, Terribacillus
  16s
gcagttactctcgtacttgttcttccctaacaacagagctttacgacccgaaggccttcatcgctcacgcggcgttgctccgtcagactttcgtccattgcggaagattccctactgctgcctcccgtaggagtctgggccgtgtctcagtcccagtgtggccgatcaccctctcaggtcggctatgcatcgtcgccttggtgggccattaccccaccaactagctaatgcaccgcgggcccatctgtaagtgacagccgaaaccgtctttccatttccaatcaggagaaaggaaatactatccggtattagctccggtttcccgaagttatcccagtcttacaggcaggttgcccacgtgttactcacccgtccgccgctcattccgccagaatcaccccgaaggggtaatctggtttcctgcgctcgacttgcatgtattaggcacgccgccagcgttcgtcctgagccatga

SEQ ID NO: 2 - DNA, 487 bp, Terribacillus
cgtcaggtacgagcagttactctcgtacttgttcttccctaacaacagagctttacgacccgaaggccttcatcgctcacgcggcgttgctccgtcagactttcgtccattgcggaagattccctactgctgcctcccgtaggagtctgggccgtgtctcagtcccagtgtggccgatcaccctctcaggtcggctatgcatcgtcgccttggtgggccattaccccaccaactagctaatgcaccgcgggcccatctgtaagtgacagccgaaaccgtctttccatttccaatcaggagaaaggaaatactatccggtattagctccggtttcccgaagttatcccagtcttacaggcaggttgcccacgtgttactcacccgtccgccgctcattccgccagaatcaccccgaaggggtcatctggtttcctgcgctcgacttgcatgtattaggcacgccgccagcgttcgtcctgagccatga

SEQ ID NO: 3 - DNA, 482 bp, Terribacillus
ggtacgagcagttactctcgtacttgttcttccctaacaacagagctttacgacccgaaggccttcatcgctcacgcggcgttgctccgtcagactttcgtccattgcggaagattccctactgctgcctcccgtaggagtctgggccgtgtctcagtcccagtgtggccgatcaccctctcaggtcggctatgcatcgtcgccttggtgggccattaccccaccaactagctaatgcaccgcgggcccatctgtaagtgacagccgaaaccgtctttccatttccaatcaggagaaaggaaatactatccggtattagctccggtttcccgaagttatcccagtcttacaggcaggttgcccacgtgttactcacccgtccgccgctcattccgccagaatcaccccgaaggggtcatctggtttcctgcgctcgacttgcatgtattaggcacgccgccagcgttcgtcctgagccatga

SEQ ID NO: 4 - DNA, 474 bp, Terribacillus
gcagttactctcgtacttgttcttccctaacaacagagctttacgacccgaaggccttcatcgctcacgcggcgttgctccgtcagactttcgtccattgcggaagattccctactgctgcctcccgtaggagtctgggccgtgtctcagtcccagtgtggccgatcaccctctcaggtcggctatgcatcgtcgccttggtgggccattaccccaccaactagctaatgcaccgcgggcccatctgtaagtgacagccgaaaccgtctttccatttccaatcaggagaaaggaaatactatccggtattagctccggtttcccgaagttatcccagtcttacaggcaggttgcccacgtgttactcacccgtccgccgctcattccgccagaatcaccccgaaggggtcatctggtttcctgcgctcgacttgcatgtattaggcacgccgccagcgttcgtcctgagccatg

SEQ ID NO: 5 - DNA, 20 bp, Artificial Sequence
  Primer
tcgacgacctcccagaatac

SEQ ID NO: 6 - DNA, 20 bp, Artificial Sequence
  Primer
ccttgtagccgatcttcagc

SEQ ID NO: 7 - DNA, 21 bp, Artificial Sequence
  Primer
acgccgatcagttcaagctat

SEQ ID NO: 8 - DNA, 20 bp, Artificial Sequence
  Primer
cctggttcgtgtaggtctgg

SEQ ID NO: 9 - DNA, 477 bp, Terribacillus halophilus
  misc_feature 32: /note=“unknown”
cgtcaaggtacaagcagttactcttgtacttnttcttccctgacaacagagctttacgacccgaaggccttcatcgctcacgcggcgttgctccgtcagactttcgtccattgcggaagattccctactgctgcctcccgtaggagtctgggccgtgtctcagtcccagtgtggccgatcaccctctcaggtcggctatgcatcgtcgccttggtgggccattaccccaccaactagctaatgcaccgcgggcccatctgtaagtgacagccgaaaccgtctttccatttccaatcaggagaaaggaaatactatccggtattagctccggtttcccgaagttatcccagtcttacaggcaggttgcccacgtgttactcacccgtccgccgctcattccgccagaatcaccccgaaggggtcatctggtttcctgcgctcgacttgcatgtattaggcacgccgccagcgttcgtc

SEQ ID NO: 10 - DNA, 477 bp, Terribacillus saccharophilus
  misc_feature 401: /note=“unknown”
cgtcaaggtacgagcagttactctcgtacttgttcttccctaacaacagagctttacgacccgaaggccttcatcgctcacgcggcgttgctccgtcagactttcgtccattgcggaagattccctactgctgcctcccgtaggagtctgggccgtgtctcagtcccagtgtggccgatcaccctctcaggtcggctatgcatcgtcgccttggtgggccattaccccaccaactagctaatgcaccgcgggcccatctgtaagtgacagccgaaaccgtctttccatttccaatcaggagaaaggaaatactatccggtattagctccggtttcccgaagttatcccagtcttacaggcaggttgcccacgtgttactcacccgtccgccgctcattccnccagaatcaccccgaaggggtcatctggtttcctgcgctcgacttgcatgtattaggcacgccgccagcgttcgtc

(19) United States
(12) Patent Application Publication
(10) Pub. No.: US 2018/0072633 A1
(43) Pub. Date: Mar. 15, 2018

(54) AGRICULTURAL METHODS

(71) Applicant: AZOTIC TECHNOLOGIES LTD, Chorley, Lancashire (GB)

(72) Inventors: David DENT, Fleet Hampshire (GB); Inmaculada DEL CASTILLO MADRIGAL, Nottingham Nottinghamshire (GB)

(21) Appl. No.: 15/327,001

(22) PCT Filed: Jul. 28, 2015
(86) PCT No.: PCT/GB2015/052171

§ 371 Date: Jan. 17, 2017

(30) Foreign Application Priority Data
Jul. 28, 2014 (GB) 1413335.9

(51) Int. Cl. C05F 11/08; A01N 63/00; C05G 3/02

(52) U.S. Cl. CPC C05F 11/08; C05G 3/02; A01N 63/00

(57) ABSTRACT

A method for introducing a plant growth mediating entity or substance into plants and in particular a nitrogen-fixing bacteria into plant cell, said method comprising administering said plant growth mediating entity or substance into plants to a plant in combination with a strain of Terribacillus.

Compositions and bacteria for use in the method form a further aspect of the invention.

### FIELD

The present invention relates to a method for enhancing plant growth, as well as to microorganisms and compositions comprising these that are useful in this method.

### BACKGROUND

It is known that nitrogen-fixing bacteria Gluconacetobacter diazotrophicus (Gd) is able to colonise plant cells (intracellular colonisation) and therefore to enhance the growth of those plants (EP-A-142299). However, the ability of various strains of Gd to effect this useful function can vary depending upon factors such as the nature of the crop, the mode of application and the particular strain of Gd used. It has been found for instance that sugar rich crops such as sugar cane or sugar beet may be more readily colonised by Gd and may support a higher level of colonisation. Furthermore, the ability to colonise plants intracellularly may be variable from strain to strain of Gd. Whilst certain strains have demonstrated the ability to colonise cells efficiently under various administration conditions, others such as those described in WO2010/022517 for instance appear to operate intercellularly to a large extent. It is expected that intracellular colonisation provides a more efficient and effective means of enhancing the nitrogen supply of plants and thus improving plant growth.

The applicants have found a further bacterial strain that facilitates the colonisation of plant cells by bacteria, and in particular nitrogen-fixing bacteria.

Development work carried out with using a strain of Gd, obtained originally from Mexico, which was known to colonise plant cells found that after extensive culture of the initial strain, the colonization properties of the strain appeared to improve. Characterisation of the strain at that point revealed the surprising finding that there was in fact, a separate bacteria, intimately associated with the Gd. This strain was characterized as a Terribacillus, a spore forming Gram-positive bacteria, and very closely related to Terribacillus saccharophilus and Terribacillus halophilus.

It has been suggested previously that this strain may be used in the biocontrol of grey mould in strawberry fruits (Esshaier et al. Journal of Applied Microbiology (2009) 106 833-846), and further that it may enhance plant germination (WO2014/193746) or have plant growth promoting activity (WO2104/201044).

The co-existence of these two organisms is extremely surprising and indeed, is believed to be unprecedented. It is unclear how the Terribacillus, became associated with a Gd strain in this way. Terribacillus is an organism found previously in soil in Japan or India (Sun-Young An et al., Int. J. of Systematic and Evolutionary Microbiology (2007), 57, 51-55, Kadyan S, et al. World J Microbiol Biotechnol. 2013; 29: 1597-1610) and also as an endophytic bacteria in some plants (Preveena et al, Anc. Sci Life (2013) 32(3): 173-7, Chandna P, et al. BCM Microbiology. 2014, 14: 33). However, it appears that Terribacillus may interact with plant cells in such a way that they may penetrate into the plant cells, thus facilitating the plant colonizing activity of a useful nitrogen-fixing bacteria such as Gd. In particular, Terribacillus appears to act in consortium with a nitrogen-fixing bacteria such as Gd to facilitate entry into and colonisation of the plant cells.

### SUMMARY

According to the present invention, there is provided a method for introducing a plant growth mediating entity or substance into plant cell, said method comprising administering said plant growth mediating entity or substance to a plant in combination with a strain of Terribacillus.

### DETAILED DESCRIPTION

The applicants have found that Terribacillus and in particular Terribacillus saccharophilus or Terribacillus halophilus as exemplified by strains comprising any one of SEQ ID NOS 1-4 can colonise plants. However, other strains of Terribacillus may be used including Terribacillus goriensis or Terribacillus aidingensis. Colonisation may be intercellular or it may enter plant cells (intracellular colonisation).

As a result, these bacteria may be used to transport plant growth mediating entities or substances into plants and even into plant cells.

Suitably plant growth mediating substances are any substances which impact on the health or well-being as well as the growth characteristics of a plant as understood in the art.

They may include agrochemical compounds or small molecules such as fungicides, herbicides, insecticides or plant growth regulators.

In particular however, they will comprise biological substances.

These may include nucleic acids, such as DNA or RNA molecules. For example, the nucleic acid may be an RNA molecule, for instance, an RNAi, such as a microRNA (miRNA) or a small interfering RNA (siRNA) which inhibits a plant virus. The plant virus may be any of the known plant viruses but particular examples include tobacco mosaic virus, tomato spotted wilt virus, tomato yellow leaf curl virus, cucumber mosaic virus, potato virus Y, cauliflower mosaic virus, African cassava mosaic virus, plum pox virus, brome mosaic virus and potato virus X, citrus tristeza virus, barley yellow dwarf virus, potato leafroll virus, and tomato bushy stunt virus.

Alternatively the biological substance is a protein or peptide, such as an effector protein, a plant hormone, an insecticide or plant growth regulating substance.

The plant growth mediating substance may be administered with the Terribacillus either separately or in admixture.

However, if the Terribacillus is to be used in this way, it is suitably genetically modified so that it expresses and in particular also secretes the biological substance required in a plant. Genetic transformation may be achieved using conventional recombinant DNA technology, in particular by transforming a strain of Terribacillus with a vector which comprises a nucleic acid sequence encoding said biological substance. The transformed cells may be cultured to produce a strain for administration to plants. Genetically transformed Terribacillus and methods for their preparation are novel and form a further aspect of the invention.

In a particular embodiment however, the growth mediating entity or substance is a different bacteria such as a live nitrogen-fixing bacteria. Whilst nitrogen-fixing bacteria are well known to have beneficial effects in plants and therefore form a particular embodiment of the invention, the applicants have found that Terribacillus can interact with bacteria to modify production of substances such as plant hormones like Indole Acetic Acid (IAA).

Indole acetic acid (IAA) is one of the most physiologically active auxins. IAA is a common product of L-tryptophan metabolism by several microorganisms including PGPR. It has been reported that Gd produced IAA in high concentrations. IAA promotes root elongation in plants but excessive amounts of this hormone in the plant environment could lead to the inhibition of the plant growth. Regulation of the production of IAA by Gd therefore may provide have benefits for plant development.

As a result, where hormones such as IAA are produced by a bacteria and the production is modified, for example increased, as a result of the presence of Terribacillus, those bacteria may be administered to the plant with the Terribacillus in order to provide a modified supply of plant hormone.

However, according to a particular embodiment of the present invention, there is provided a method for introducing a nitrogen-fixing bacteria into plant cell, said method comprising administering said nitrogen-fixing bacteria to a plant in combination with a strain of Terribacillus.

The applicants have found that Terribacillus and in particular Terribacillus saccharophilus (Ts) or Terribacillus halophilus as exemplified by strains comprising any one of SEQ ID NOS 1-4 can enhance the effect of a nitrogen-fixing bacteria such as Gd on plants. Without being bound by theory, this may be because Terribacillus facilitates colonisation of plant cells by nitrogen-fixing bacteria such as Gd, for example by increasing levan production in the Gd, or by supplying its own levan which may act as a carbon source for the Gd, or otherwise improves nitrogen fixing for example by improving nitrogenase activity.

The applicants have found evidence that Gd genes responsible for both nitrogenase activity and levansucrase production (nifH and lsdA) respectively are up-regulated in mixed cultures of Terribacillus such as Ts and Gd. Furthermore, Terribacillus such as Ts appears to adhere well to surfaces such as seed surfaces and to enhance adherence in mixed cultures. This property may assist in the formation of biofilm that can facilitate colonisation.

As a result, these bacteria may be used to improve plant growth, for example by improving the plant colonisation properties of the nitrogen-fixing bacteria or by other means. The nitrogen-fixing bacteria is suitably administered with the Terribacillus either separately or in admixture, but preferably in a co-culture.

It appears that the Terribacillus is able to become intimately associated with other bacteria, in particular those which form a levan coat, which may provide a support environment for the Terribacillus. A particular example of such nitrogen-fixing bacteria is Gluconacetobacter diazotrophicus (Gd). However, Terribacillus may also facilitate the introduction into plant cells of other nitrogen-fixing bacteria such as Azotobacter, Beijerinckia, Clostridium, Rhizobium, Klebsiella and Spirillum lipoferum.

The Terribacillus is suitably intimately associated with the nitrogen-fixing bacteria such as Gd prior to administration. In particular, the bacteria may be co-cultured together. Thus for example, a sample of Terribacillus bacteria may be added to a culture of nitrogen-fixing bacteria such as Gd and the resultant mixture cultured. In the case of some bacteria and in particular Gd, once a suitable co-culture has been established, there may be no need to introduce further Terribacillus since the bacteria become difficult to separate under certain conditions. However, in other instances, strains may be separable for example by culturing in media which favours the growth of one strain over another, as illustrated hereinafter.

Suitable culture conditions include provision of a suitable bacterial growth medium, such as agar containing media such as Marine Agar. The medium may contain additional bacterial nutrient if required, including for example a 3% (w/v) sucrose solution as described in EP-A-1422997. Culture may be carried out at a range of temperatures for example at from 20-37° C. and typically at about 25° C.

In a particular embodiment, a combination of Terribacillus such as Ts and Gd is prepared by a process in which each strain is cultured individually, and the resulting strains are mixed just prior to use, in the required ratios. This method has the advantage that the media may be selected to ensure good or optimal growth for the particular strain being grown. Thus for instance, Gd may be beneficially grown in a medium comprising potato dextrose broth/agar (PDB/PDA, Fluka), or ATGUS as described in Cocking et al. 2006 In Vitro Cellular and Developmental Biology—Plant, Volume 42, 74-82 as well as sucrose based media such as LGIP as described by Calvalcante & Dobereiner, Plant and Soil, 108, 23-31.

Similarly, Terribacillus such as Ts may suitably be grown on Luria-Bertani Broth (LB) (Sambrook and Russel, Molecular Cloning: A Laboratory Manual, New York, Cold Spring Harbor Press, (2001)) or on Marine Agar (Difco). However, the applicants have found that there are certain media in which both Terribacillus such as Ts and Gd may be supported.

In a particular embodiment, a co-culture is prepared by growing both Terribacillus and Gd in the same media. Such media include in particular mannitol or sucrose based media, for example MYP media (d-mannitol, yeast extract and peptone) as described for example by Yamada et al. Biosciences, Biotechnology and Biochemistry, volume 61, 1244-1251 or SYP media of sucrose, yeast extract and potassium salts (mono- and di-potassium phosphate) as described by da Silva-Froufe et al. Brazilian Journal of Microbiology, 40 (4) 866-878. Other media may be selected and tested if required, using conventional methodology. Media may suitably comprise both sucrose, to support particularly Gd, and salt (NaCl) to enhance Terribacillus such as Ts growth.

In this way, co-cultures may be prepared efficiently and simply, without the need for subsequent mixing. Methods of preparing such co-cultures in this way form a further aspect of the invention.

The relative amounts of Terribacillus to nitrogen-fixing bacteria will be variable depending upon factors such as the bacterial growth, the specific strain of nitrogen-fixing bacteria employed, etc. Typically, the nitrogen-fixing bacteria remains the predominant strain present. For example the amount of Terribacillus present in the combination is suitably from 0.1-45% of the total bacteria, such as from 1-40%, including from 1-20%, for example about 5%. Where co-cultures are used, the ratio of the strains may depend upon how well each strain grows within the particular medium used to produce the culture. However, where the cultures are mixed for application, the ratios may be more readily selectable. Generally, the Gd is present in an excess, and a ratio of Gd:Terribacillus of about 2:1 has been found to provide optimum nitrogenase activity.

The combination of Terribacillus and nitrogen-fixing bacteria is administered to plant cells in a manner which is suitable to allow them to enter the plant cell. For example, the combination of Terribacillus and nitrogen-fixing bacteria is administered to a growing plant. For instance, the combination may be applied to a plant or to the growth medium thereof on germination or shortly thereafter, for example within 1 to 7 days of germination using methods described for example in EP-A-142299.

In another embodiment, the compositions are applied using a known ‘in furrow’ technique, in which the composition is applied to the seed furrow during the planting operation.

In another embodiment, a plant is subjected to a wounding process prior to administration of said combination. This method is described in relation to the administration of nitrogen-fixing bacteria in a co-pending British Patent Application of the applicants. The wound may be a result of accidental or natural damage, whereupon the nitrogen-fixing bacteria may facilitate repair growth. However, in a particular embodiment, the wound is the result of damage caused by actions such as mowing (amenity grass), cutting (silage and hay crops), ratooning (banana, pineapple, sugarcane, sorghum, rice, pigeonpea, cotton, Abaca, Ramie), pruning (fruit trees, vines), consumption by livestock or by harvesting. In particular, the wound will be found in an ‘above-ground’ part of the plant, such as leaves or stems.

This embodiment may further comprise a preliminary step of inflicting ‘damage’ on the plant, in particular by mowing, cutting, rationing, pruning or by harvesting. The combination is suitably applied within a relatively short time period of carrying out such actions, for instance, within 48 hours, for instance within 24 hours, such as within 10 hours and suitably within 1-2 hours of damage being inflicted on the plant.

Alternatively, the combination of Terribacillus and nitrogen-fixing bacteria is administered to a seed for example as a seed coating.

In these instances, each of Terribacillus and nitrogen-fixing bacteria may be administered in the form of an agricultural composition. The compositions may be administered sequentially or simultaneously, or they may be admixed together.

Agricultural compositions comprising a strain of Terribacillus and for example agriculturally acceptable carrier are novel and form a further aspect of the invention. The Terribacillus may be in dried form, for example in freeze-dried form, which are reconstitutable on addition of water. Furthermore, if required, they may be microencapsulated to enhance stability.

In particular however, the composition will further comprise a plant growth mediating entity or substance. Where the Terribacillus is a recombinant strain which expresses the plant growth mediating substance, this may comprise the sole active component of the agricultural composition.

In particular however, the composition will further comprise a nitrogen-fixing bacteria.

In a particular embodiment, an agricultural composition comprises Terribacillus and a nitrogen-fixing bacteria, such as Gluconacetobacter diazotrophicus (Gd). The strain of Terribacillus is suitably a Terribacillus saccharophilus or Terribacillus halophilus but may also be Terribacillus goriensis or Terribacillus aidingensis and in particular is a strain of Terribacillus saccharophilus which comprises any one of SEQ ID NOS 1-4.

The combination of Terribacillus and nitrogen-fixing bacteria may be in the form of a co-culture, which may be in dried form, for example in freeze-dried form, which are reconstitutable on addition of water as described above. The combination or co-culture may be microencapsulated as described above to enhance stability.

The composition of the invention suitably comprises a solvent such as water although organic solvents, such as vegetable oils or hydrocarbons such as paraffin or kerosene oils may be used if required. Suitably any organic solvent is a vegetable oil such as soybean oil, sunflower oil, canola oil (oilseed rape oil), cottonseed oil, castor oil, linseed oil or palm oil or mixtures of these.

The composition may further comprise additives or excipients such as thickening agents, dispersants, diluents, humectants, solid carriers etc. as are known in the art.

In a particular embodiment, the composition further comprises a polysaccharide. Suitable polysaccharides include hydrocolloid polysaccharides derived from plant, animal or microbial sources.

In particular, these include exudate gum polysaccharides such as gum Arabic, gum ghatti, gum karaya and gum tragacanth, cellulosic derivatives such as carboxymethylcellulose, methylcellulose, hydroxypropyl cellulose, hydroxypropyl methylcellulose or microcrystalline cellulose, starches and derivatives including, for instance corn starch, tapioca starch, potato starch, rice starch, wheat starch, and modified versions thereof such as pregelatinized starch, oxidized starch, ethylated starch, starch dextrins or maltodextrin, pectin, polysaccharides derived from seaweed such as agar, alginates, carrageenan, and fucellaran, seed gums such as guar gum and locust bean gum, polysaccharides derived from microbial fermentation such as xanthan gum and gellan gum, and nitrogen containing polysaccharides such as chitosan; or mixture of these.

In a particular embodiment, the polysaccharide is exudate gum polysaccharide such as gum Arabic, gum ghatti, gum karaya or gum tragacanth. A particular example of the polysaccharide is gum Arabic.

The amount of polysaccharide present will be variable depending upon the intended mode of administration. However, typically, a composition comprising from 0.1 to 1% (w/w, for example from 0.1 to 0.5% w/w such as about 0.3% w/w polysaccharide is used. For instance, 0.1 to 1% (w/v), for example from 0.1 to 0.5% (w/v) such as about 0.3% (w/v) polysaccharide is used.

The composition may further comprise a surfactant or detergent. Suitable surfactants or detergents include non-ionic detergents such as those sold under the trade name ‘Tween’®, for example Tween 80. Tween 80 is a non-ionic detergent; 70% composed of the fatty acid oleic acid and the remainder a combination of linoleic, palmitic and stearic acids. The pH of a 1% solution is in the range of from 5.5-7.2. It is widely used for emulsifying and dispersing substances in medicinal and food products. It has little or no activity as an anti-bacterial agent (Dawson et al. (1986) Data for Biochemical Research, 3rd ed., Oxford University Press (New York, N.Y.: 1986), p. 289).

The amount of surfactant present in the composition will vary depending upon factors such as the particular surfactant, the type of treatment being carried out, and the method of administration. However, typically, a composition will comprise from 0.0005 to 0.2% (v/v) for example from 0.0005 to 0.15% (v/v) such as about 0.001% (v/v).

Suitably a nutrient for the Terribacillus and the nitrogen-fixing bacteria present is also provided in the composition and a typical nutrient will be 3% (w/v) sucrose solution as described in EP-A-1422997.

Applications of the Terribacillus have not previously been elucidated. Thus, a further aspect of the invention provides the use of a strain of Terribacillus in agriculture, in particular to transfer a plant growth mediating entity or substance, in particular a nitrogen-fixing bacteria, into plants and in particular into plant cells. Again, the strain of Terribacillus is suitably a Terribacillus sacchrophilus or Terribacillus halophilus as well as Terribacillus goriensis or Terribacillus aidingensis, and in particular comprises any one of SEQ ID NOS 1-4.

A strain of Terribacillus saccharophilus for example which comprises any one of SEQ ID NOS 1-4 suitably in isolated or purified form for use in the invention.

Alternatively, the invention provides a recombinant strain of Terribacillus which has been transformed so that it expresses a plant growth mediating substance as described above.

In a further aspect, the invention provides a combination obtained by mixing together a strain of Terribacillus and a strain of nitrogen-fixing bacteria for use in agriculture. The nitrogen-fixing bacteria is suitably a bacteria which forms a levan coat, such as Gd. It is possible that the Terribacillus which is suitably a strain as described above, may become associated with that coat, for example it is located in or on said coat.

As described above, Terribacillus may be able to facilitate entry of nitrogen-fixing bacteria into cells and as a result, may be transported into the cells with the bacteria. In yet a further aspect, there is provided a plant or seed which is colonised by Terribacillus, in particular having intracellular Terribacillus, which may be in combination with a nitrogen-fixing bacteria as described above.

Once a plant has been colonised in this way, seeds of the plant, or other progeny will also comprise intracellular Terribacillus, and where used also a nitrogen-fixing bacteria such as Gd, and these form a further aspect of the invention.

### BRIEF DESCRIPTION OF THE DRAWINGS

The invention will now be particularly described by way of example with reference to the accompanying diagrammatic drawings in which:

FIG. 1A shows PCR Fingerprints of samples of DNA extracted using a QIAamp DNA Stool kit from the nitrogen fixing bacteria Gd, where the PCR was carried out using the BOX primer.

Lanes left to right represent 1=100 bp ladder, 2,3=LN rep 1; 4,5=LN rep2; 6,7=LN rep 3; 8,9=LN rep 4; 10,11=LN rep 5, 12,13=FD rep A1, 14,15=FD rep A2, 16,17-FD rep A3; 18=control; 19=100 bp ladder; where LN=liquid nitrogen, FD=Freeze dried.

FIG. 1B shows PCR Fingerprints of samples of DNA extracted using a QIAamp DNA Stool kit from the nitrogen fixing bacteria Gd, where the PCR was carried out using the BOX primer. Lanes left to right represent 1=100 bp ladder, 2,3=FD rep A4; 4,5=FD rep A5; 6,7=LN rep 1; 8,9=LN rep 2; 10,11=LN rep 3, 12,13=LN rep 4, 14,15=LN rep 5, 16,17=unpreserved; 18=control; 19=100 bp ladder; where LN=liquid nitrogen, FD=Freeze dried.

FIGS. 2A-D show PCR fingerprints of “clonal” single colony samples of DNA extracted from bacteria using a Qiagen DNeasy Tissue kit, and amplified using BOX primers wherein in all sets, the lanes running left to right represent: 100 bp ladder; colony 1 triplicate reactions; colony 2 triplicate reactions; colony 3 triplicate reactions; colony 4 triplicate reactions; No DNA control; 100 bp latter. FIG. 2A, day 1. FIG. 2B, day 2. FIG. 2C, day 3. FIG. 2D, day. 4.

FIG. 3 shows multiple sequence alignments of the organism found in this work and Terribacillus species where DD2BR, DD1BR, DD3BR and DD4BR are the sequences isolated in this work and represent SEQ ID NOS 1-4 respectively, and where AB243849 is the corresponding Terribacillus halophilus sequence (SEQ ID NO 9) and AB243845 is the corresponding Terribacillus sacchrophilus sequence (SEQ ID NO 10).

FIG. 4 shows a comparison of growth curve for Gd (A, low oxygenation; ∘, high oxygenation) and Ts (•) in PDB, along 52 hours. Cell number for Gd culture with high oxygenation as log₁₀ (cfu/ml) (□). OD as the average of duplicate samples. Cell number at each time is represented as the average of three dilutions plated by duplicate. Error bars as standard deviation from every plates.

FIG. 5 shows a growth curve for Ts in LB. Cell number for Ts culture as log₁₀ (cfu/ml) (Δ). OD is the average of duplicate samples (∘). Cell number at each time is represented as the average of three dilutions plated by duplicate. Error bars as standard deviation from every plates.

FIG. 6 is a graph showing a comparison of the growth of Gd, Ts and a mixed culture of Gd+Ts in different media, with and without inclusion of Herbst's artificial seawater (H's).

FIGS. 7A-D show the results of competence assays over 120 hours. FIG. 7A shows growth in MYP as OD at 600 nm. FIG. 7B shows growth in SYP as OD at 600 nm. FIG. 7C shows viability of cells grown in MYP as colony forming units per ml (cfu/ml). FIG. 7D shows viability of cells grown in SYP as colony forming units per ml (cfu/ml).

FIG. 8 shows the correlation between ethylene production by Gd single cultures and Gd+Ts mixed cultures, in different proportions of both strain Gd:Ts as compared to their OD at 600 nm, as follows: (•) Gd:Ts 2:1; (⋄) Gd:Ts 1:1; (Δ) Gd:Ts 1:2. Both, trendline as regression equation are labelled with the pattern shown by the legend.

FIG. 9 shows levan production by single (G) and mixed cultures (GT) in two different media, MYP and SYP, along 15 days post-inoculation (dpi). Average of two repetitions. Error bars represent standard deviation for the average value. Groups of significant difference between each sample along time (a, b and α, β) and between different samples at each sampling time (A, B, C, D) are labelled.

FIG. 10 shows nifH and lsdA relative expression for mixed cultures (Gd+Ts) in relation to single culture (Gd) in two different media (SP and MP). Gene expression was quantified using RT-qPCR. 23S was used as reference gene for data normalization. For each condition, C_{T} was measured from three repetitions.

FIG. 11 is a graph showing the results of an experiment to determine the ability of Gd, Ts and mixed cultures of both strains, in different proportions, to attach an artificial surface. Data are the average of five independent samples±standard errors (se) of the means. Values with common letter are not significantly (F≦0.05) different according to LSD test.

FIG. 12 is a graph showing the number of cells recovered from the surface of seeds after inoculation, as log₁₀ of cfu per seed. Data are the average of three replicates±se of the means. Values with common letter are not significantly (F≦0.05) different according to LSD test.

FIG. 13 is a graph showing colonisation of OSR plants by Gd, 2 weeks post-inoculation and after incubation of the plants in a plant growth chamber. In this figure ‘OREP’ represents oilseed rape root epiphytic result, ‘OREN’ represents oilseed rape root endophytic result and ‘OLEN’ represents oilseed rape leaf endophytic results. Data are the average of cfu counted in four plates per sample (as log₁₀ of cfu/ml)±se of the means. Values with common letter are not significantly (F<0.05) different according to LSD test.

FIG. 14 is a graph showing colonisation of OSR plants by Ts, after 2 weeks post-inoculation and incubation of the plants in a plant growth chamber (Fitotron). Data are the average of cfu counted in four plates per sample (as log₁₀ of cfu/ml)±se of the means. Values with common letter are not significantly (F<0.05) different according to LSD test.

FIGS. 15A-C graphically show results of an experiment measuring plants weights after various treatments: FIG. 15A shows the wet weight measured, FIG. 15B shows the dry weight measured and FIG. 15C shows the derived weight of water. Data are the average of seven plants per sample±se of the means. Values with common letter are not significantly (a and c, F<0.05; b, F=0.1) different according to LSD test.

FIG. 16 is a graph showing levan quantification for Gd, Ts and mixed cultures in SYP after 3 days. Data are the average of three repetitions±se of the means. Values with common letter are not significantly (F<0.001) different according to LSD test.

FIG. 17 is a graph showing the effect of Terribacillus on the production of the plant hormone, IAA, on Gd. The values show the average between three repetitions and the error bars show the standard error (se). Samples with the same letter has no significant differences according with LSD test (F<0.001)

### EXAMPLE 1

### Identification of Combination

Work was undertaken to characterise strains of Gd. The strains used included a ‘test strain’ which had been cultured from IMI 501986, (now IMI 504998) available from Azotic Technologies Ltd and CABI UK, over a long period of time and which was known to have good plant cell colonisation properties.

The strains were grown initially on ATGUS medium ([0.8% (w/v) agar, yeast extract (2.7 g L⁻¹), glucose (2.7 g L⁻¹), mannitol (1.8 g L¹), MES buffer (4.4 g L⁻¹), K₂HPO₄ (0.65 g L⁻¹), pH 6.5], and incubated at 25° C. It was found however that the use of ATGUS broth improved the quality and reproducibility of the strains.

PCR fingerprinting was undertaken on pre- and post-preservation samples (including cryopreserved and freeze dried samples of the strains. DNA extraction was carried out using the Qiagen DNeasy Plant, DNeasy tissue or QIAamp DNA Stool kits, used in accordance with the manufacturers' instructions. The DNA concentration of each sample was assessed by spectrophotometer (GeneQuant, GE Healthcare, UK). Concentration was then standardised for each sample to 10 ng/μl.

PCR fingerprinting using bacterial repeat unit BOX & ISSR ‘TGT’ primers was undertaken and gel electrophoresis used to separate the DNA fragments. All PCR reactions were undertaken in duplicate and repeated.

DNA was successfully extracted from all preserved and ‘wild-type’ samples. However, the PCR results with both the Box and TgT primers for the ‘test strain’ were inconsistent. It was expected that the banding patterns should be 100% similar across the separate replicates, but although some bands appeared common to all samples, some were distinctly different with extra bands appearing. The intensity of ‘like’ bands also differed between different treatments. The results obtained with using Box primer were generally better and contained up to 8 distinct bands.

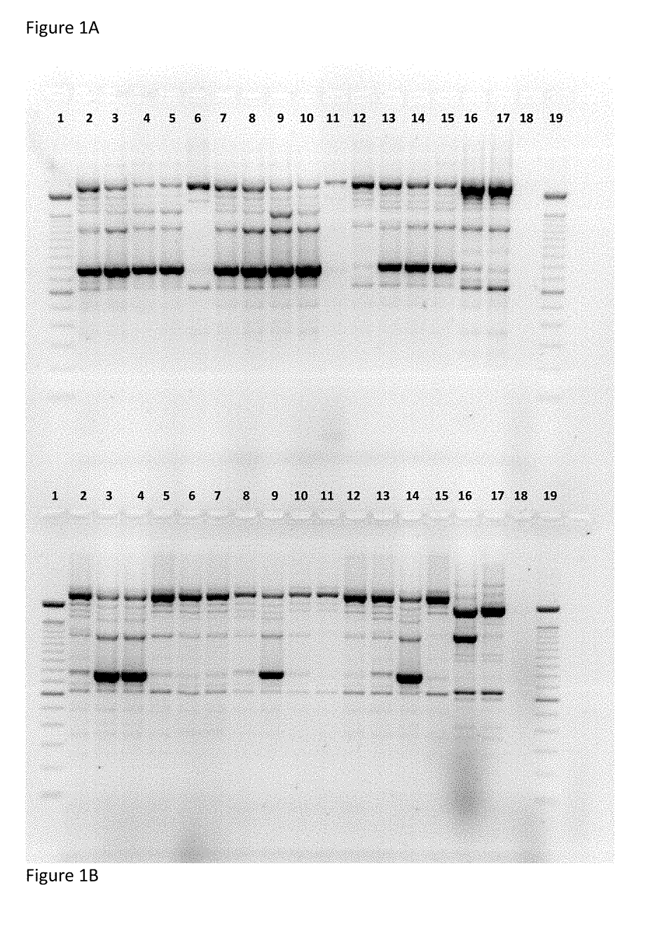

The work was repeated using DNA extracted using the QIAamp DNA Stool extraction kit. This gave fingerprints of better quality and more consistency. However, although there were common bands appearing in all samples, there were clear differences in banding profile between some replicates of the same sample (FIGS. 1A-1B). Profiles should be identical across replicates, but especially so within duplicate reactions of the same replicate. This was not the case as is clear from a comparison of the banding patterns in boxes which are associated with replicates of the same sample.

Partial 16S rDNA sequence analysis of the strains carried out at this time indicated that the organism was predominantly Gd.

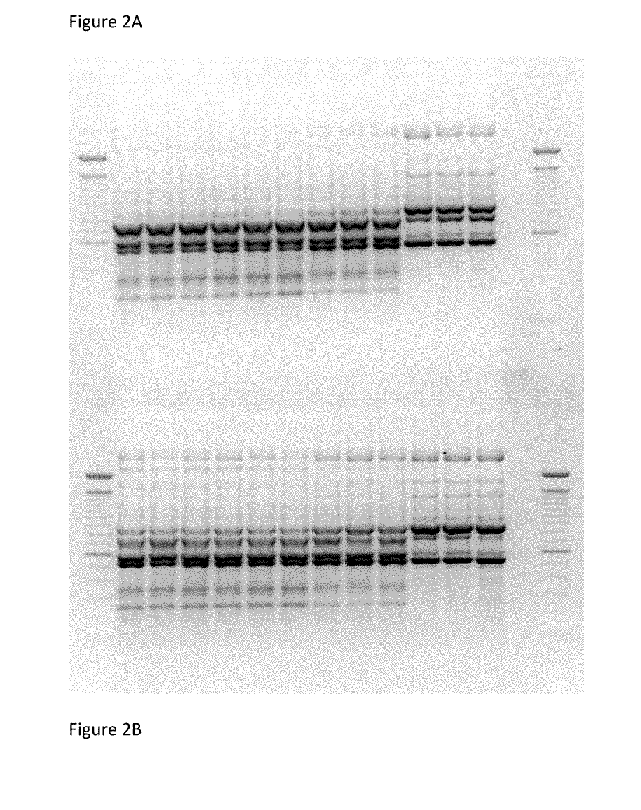

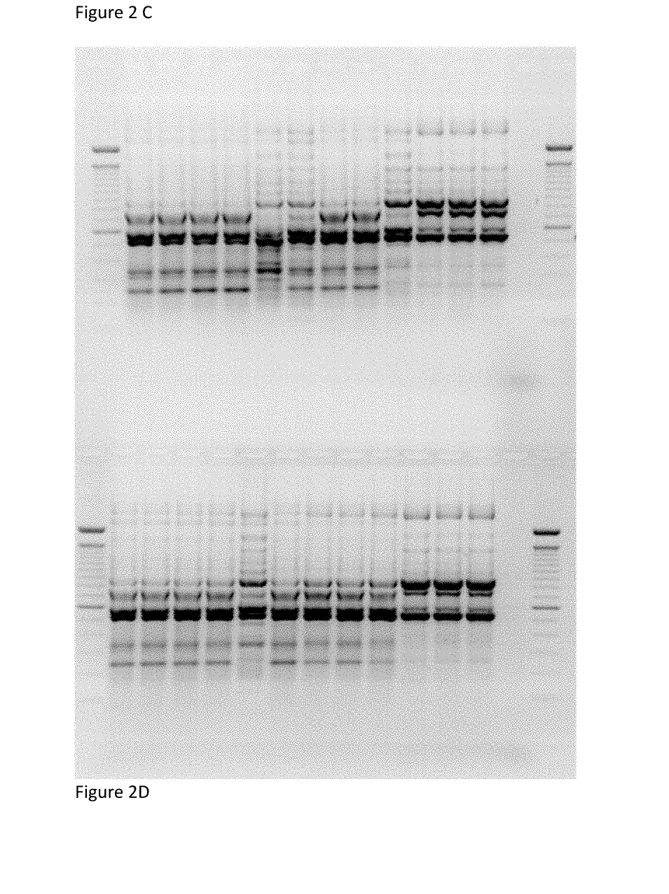

Due to the unexpected irreproducibility of the profiles, the methods were repeated in a modified manner and using four single colonies derived from a single line of the Gd in order to ensure that the samples were identical. The colonies were grown in ATGUS broth and DNA extracted from each of the four colonies using the Qiagen DNeasy tissue kit Gram positive bacteria protocol in order to remove any problems due to any potential inhibitory or protective effects of Gd levan. The samples were subjected to BOX PCR (using triplicate reactions and over four separate days) and reproducible and uniform profiles were observed (FIGS. 2A-2D).

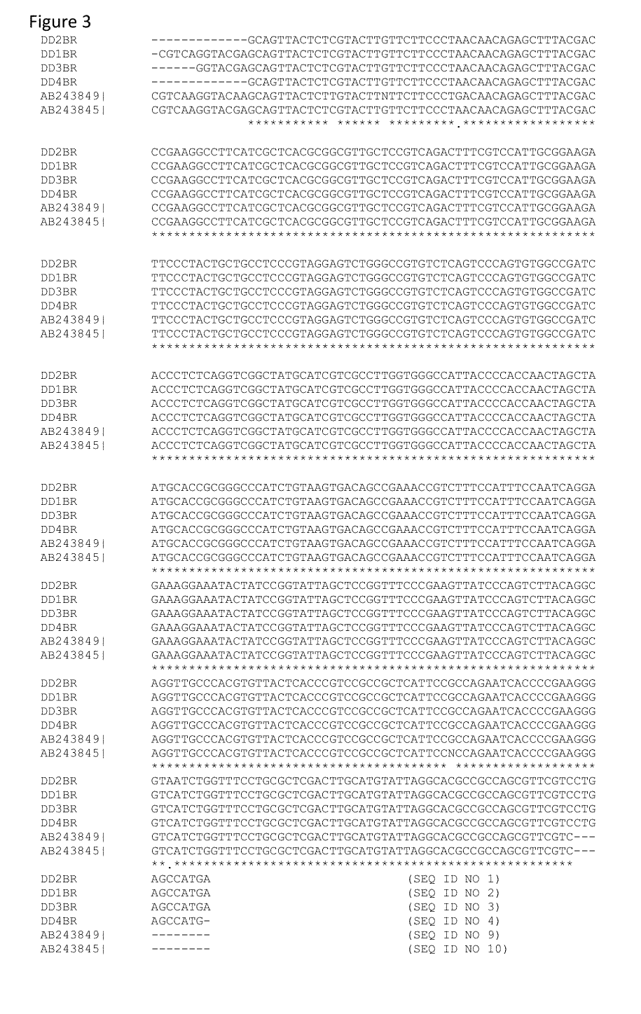

Surprisingly, subsequent partial 16S rDNA sequence analysis of the monocolony-derived samples gave >99% matches to Terribacillus spp., most closely matching T. saccharophilus (see FIG. 3)

### EXAMPLE 2

### Separation of Strains

Selective culturing of the test strain at different pH and NaCl concentrations were attempted in order to try to isolate both organisms. However, nothing grew on the NaCl media but growth was observed on the pH 5.5 agar and two morphotypes were noted on the pH 9.5 media. Information from the literature suggested that Gd would not grow at the higher pH and so it was thought that the secondary organism had been isolated. However, partial 16S rDNA sequence analysis revealed that both isolates were Gd.

Subsequent Gram staining was not conclusive, but revealed the predominance of a gram negative rod (i.e. Gd) with possible traces of a gram positive rod.

The more acidic pH conditions should favour the growth of Gd while Terribacillus should tolerate a higher pH (i.e. more alkaline) conditions more readily. It was not possible in this work to separate the Terribacillus from the Gd as indicated by the sequencing work. The fact that Gd remained the predominant strain suggests that the Terribacillus is present in the overall population of cells in very low numbers. However, in this experiment, the Gd appeared to tolerate more alkali conditions than previously described. This may be due to the presence of the Terribacillus which is acting in a mutualistic way to achieve this. In a similar way, the Terribacillus is believed to be responsible for the enhanced plant cell colonisation activity of this particular strain of Gd.

Furthermore, the difficulties encountered in separating the strains under certain circumstances is indicative of the very close association formed between these two strains. Without being bound by theory, it seems possible or even probable that the ‘sugar-loving’ property of the Terribacillus means that it can become attached to or incorporated into the levan of the Gd. Alternatively, the Gd may by using the levan of the Terribacillus as a carbon source.

### EXAMPLE 3

### Co-Culture of Strains of Terribacillus and Gd

The strains used in these experiments were Gluconacetobacter diazotrophicus, (IMI504958—CABI (UK)) and Terribacillus saccharophilus, strain provided by CBS Biodiversity Centre (AZ0008), Terribacillus goriensis (AZ0007), Terribacillus halophilus (AZ0009) and Terribacillus aidingensis (AZ0010). A range of media were used to grown the strains either individually or in combination.

A range of media, in particular those known to support the growth of Gd were tested to see whether they may also support Ts growth.

These included:
1. Potato Dextrose Broth/Agar (PDB/PDA, Fluka).
2. ATGUS (2.7 g L⁻¹ glucose, 0.65 KH₂PO₄, 4.8 g L⁻¹K₂HPO₄, 1.8 g L⁻¹ mannitol, 4.4 g L⁻¹ 2-(N-morpholino)ethanesulfonic acid (MES hydrate), 2.7 g L⁻¹ yeast extract) (Cocking, et al., 2006.)
3. Marine Agar (Difco)

In each case, starter cultures were prepared in 100 ml of broth (PDB for Gd, LB for Ts) from colonies in fresh plates and incubated at 28° C. with shaking at 150 rpm. 10 μl of the normalized cultures at OD₆₀₀ 0.1 were inoculated into centrifuge tubes with 5 ml of sterile medium, in duplicate, and incubated in the same conditions. Single tubes were used per sample, and were discarded after each use. Samples were taken at 0, 4, 8, 16, 20, 24, 28, 32, 40, 44, 48, and 52 hours after inoculation, OD₆₀₀ was measured and serial dilutions plated on PDA or Marine Agar to count number of viable cells (cfu/ml).

The results after 4 days are shown in the following Table in which different levels of growth are showed as: +++ very high growth, ++ (high growth), + (growth), (+) (not clear growth), − (no growth).

| Strain | ATGUS | Marine Agar | PDA |
|---|---|---|---|
| AZ0007 | − | ++ | (+) |
| AZ0008 | − | ++ (Pale yellow | + (White |
| | | colonies) | colonies) |
| AZ0009 | − | ++ | (+) |
| AZ0010 | − | ++ | − |
| IMI 504958 | +++ | − | +++ |

It was clear that ATGUS would not support Terribacillus growth whilst Marine Agar supported Terribacillus but not Gd. Growth of Terribacillus in PDA was not clear or reliable.

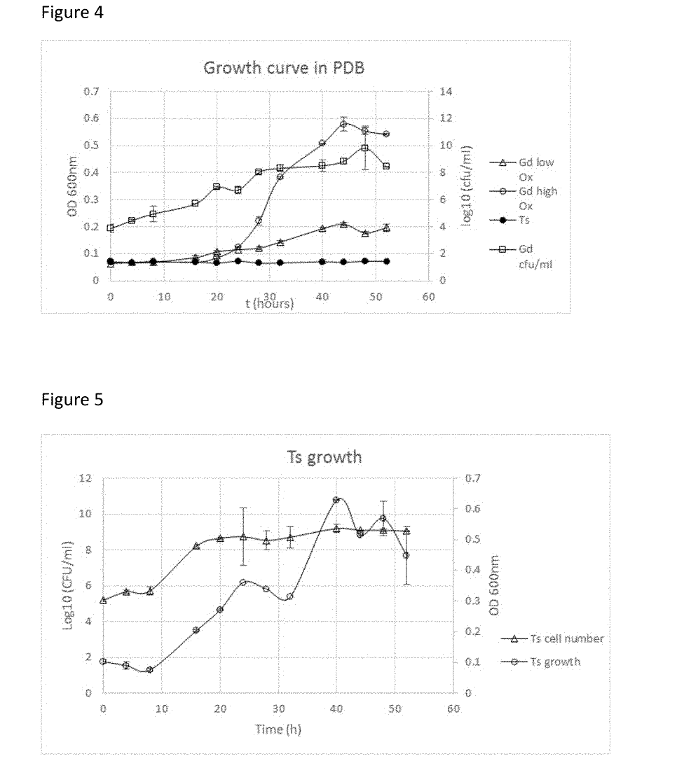

A growth curve in PDB was then constructed over 52 hours of incubation under the conditions described above and this is shown in FIG. 4. The growth of Gd was affected by the oxygenation of the culture, being slower at lower oxygenation level.

However, Ts was not able to grow in PDB after several days of incubation. It did however grow successfully in Luria-Bertani Broth (LB) (Sambrook, J. & Russel, D., 2001. Molecular Cloning: A Laboratory Manual. New York: Cold Spring Harbour Laboratory Press), as shown in FIG. 5.

Gd growth was tested in LB. Also, growth in Nutrient Agar (NA) was checked for both strains. After one week Gd did not grow on NA, nor in Marine Agar Gd grew poorly on LB.

Attempts were made to modify the media to see if they would support additional strain growth. In particular, sucrose, reported to be essential for Gd growth was added to LB. Similarly, PDB was modified by addition of sodium chloride to try to ensure that it would support Ts growth. However, the results were not successful in so far as Ts showed no ability to grow in PDB, even with a high concentration of salt, while it showed growth in LB modified with sucrose after 48 hours of incubation. Gd was affected by the salt concentration in PDB, and it was able to grow at 1% (w/v) NaCl, but not at higher salinity. It was not able to grown in LB supplemented with sucrose, suggesting a lack of compatibility in these media.

Different media were tested to see if Gd and Ts would grow together. The media were:

MYP (25 g L⁻¹ d-mannitol, 3 g L⁻¹ yeast extract, 3 g L⁻¹ peptone; pH 6.2) (Yamada, Y. et al., 1997. Biosiciences, Biotechnology and Biochemistry, Volume 61, pp. 1244-1251); and

SYP (10 g L⁻¹ sucrose, 3 g L⁻¹ yeast extract, 1 g l⁻¹ K₂HPO₄, 3 g L⁻¹ KH₂PO₄; pH 5.8) (Silva-Froufe, L., et al., (2009) Brazilian Journal of Microbiology, 40 (4), pp. 866-878).

Different carbon sources were tested with these two media, sucrose (SYP) and mannitol (MYP). To improve the growth of Ts, all suspension media were supplemented with 0.5× Herbst's artificial seawater, as recommended by An, S. et al., 2007 International Journal of Systematic and Evolutionary Microbiology, Volume 57, pp. 51-55. Media were tested with and without Herbst's solution for both strains Ts and Gd. The same was made for PDB.

Culture growth was measured with respect to the OD at λ=600 nm. Also viable cells were checked by plating on ATGUS and/or Marine Agar and Gd and Ts detected. In the case of cultures with Gd, the cultures were plated also onto LGIP to test the ability of nitrogen fixing from these cultures.

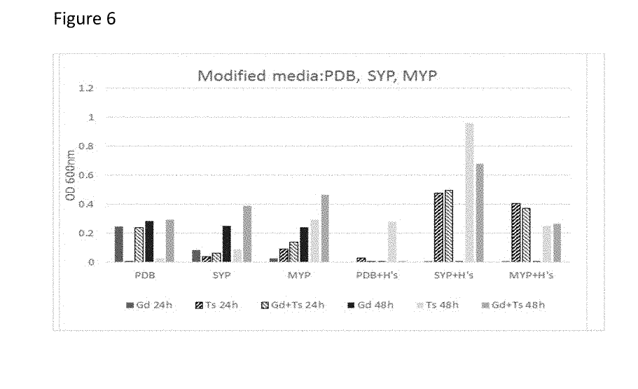

The graph in FIG. 6 shows that both strains grew well in SYP and MYP. Ts was unable to grow in PDB, except after addition of the salt solution and after a long incubation, but in this case Gd did not grow. Gd did not show growth in any media modified with artificial seawater. The mixed culture presented higher growth than single cultures without salt solution, which is likely due to the growth of both strains in the medium, as is clear from the cell viability tests, in which cells were plated on optimal growth medium (ATGUS for Gd, and Marine Agar for Ts) and incubated for 4 days. The results are presented in Table 1 below.

TABLE 1
Cell viability from cultures in modified media for
24 hours and for 48 hours. In mixed cultures, the viability
of the cells are represented as Gd/Ts. Different levels of
growth are showed as: +++ (very high growth), ++ (high
growth), + (growth), (+) (not clear growth), − (no growth).

| | Growth media | | | | | |
|---|---|---|---|---|---|---|
| | | | | PDB + | SYP + | MYP + |
| | PDB | SYP | MYP | H's | H's | H's |
| Gd 24 h | + | + | ++ | + | + | + |
| Gd 48 h | +++ | +++ | +++ | (+) | + | + |
| Ts 24 h | − | ++ | ++ | ++ | ++ | ++ |
| Ts 48 h | + | ++ | + | ++ | +++ | ++ |
| Gd + Ts 24 h | ++/− | ++/++ | ++/++ | +/(+) | +/++ | +/++ |
| Gd + Ts 48 h | ++/− | +++/− | +++/+ | (+)/+ | +/++ | +/+ |

The results show that both media, SYP and MYP, are suitable as growth media for mixed cultures of Gd and Ts. When in single culture, Ts growth was improved when these media were supplemented with Herbst's artificial seawater. However, in both media, growth of Ts slowed compared with Gd growth over time. This trend could be observed in more detail following competence assays.

In these assays, separate cultures of Gd and Ts were incubated in appropriate media for 24-48 hours at 28° C. with agitation at 150 rpm. Cultures were washed twice with 0.9% (w/v) NaCl solution to remove the used medium and OD₆₀₀ was checked and adjusted to 0.2 (˜10⁸ cfu/ml). To a final volume of 5 ml of the selected media (MYP and SYP), 1 ml of each culture (Gd and Ts) was inoculated, with one tube per sample. Samples were taken 0, 6, 24, 36, 48, 54, and 120 hours after inoculation, OD₆₀₀ measured and serial dilutions plated by duplicate on ATGUS, LGIP and Marine Agar as selective media. Single cultures of Gd and Ts were inoculated and incubated using the same conditions as control.

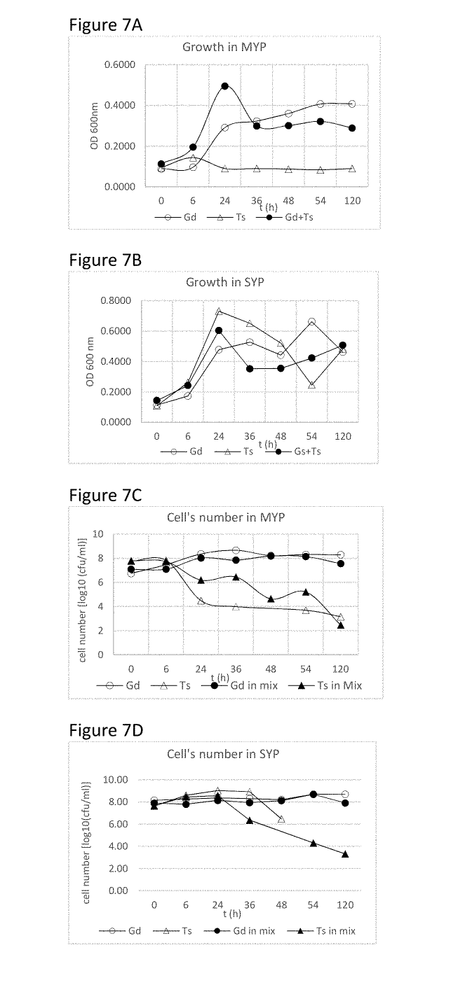

The results are shown in FIGS. 7A-7D. Both strains were able to grow in these media, but Ts grew at higher concentrations as single culture in SYP than in MYP. In the mixed culture, the behaviour of the strains were similar in SYP and MYP. This suggests that the presence of Gd provides some benefit for Ts growth in MYP. Gd growth did not seem to be affected by the presence of Ts in terms of cell viability.

As a result, these media are suitable for producing a viable co-culture of Gd and Ts.

### EXAMPLE 4

### Nitrogen Fixation In-Vitro

The reduction of acetylene (C₂H₂) to ethylene (C₂H₄) is an indirect method of measuring nitrogenase activity in natural samples (Cojho, et al., Volume 1993. 106 pp 341-346).

Cultures of Gd and Ts were prepared in MYP and SYP and incubated at 28° C., with shaking at 150 rpm. After 2 days of incubation the cultures were centrifuged (4,000 rpm, 15 min) and washed with 0.9% (w/v) NaCl solution. The resultant pellets were re-suspended in a modified media, one of which was nitrogen free; specifically the MYP and SYP media described above but without adding yeast extract (hereinafter referred to as MP and SP respectively). The OD₆₀₀ of Gd cultures were adjusted to 1 and to 0.5 for Ts. The samples were prepared by inoculation of 1 ml of Gd, for single cultures, and 1 ml Gd+1 ml Ts for mixed samples, in a final volume of 5 ml of broth in the following proportions Gd:Ts (taking as reference the OD₆₀₀ of the cultures): 1:1, 2:1 and 1:2. Tubes were sealed and 10% of air volume was replaced with acetylene. Ethylene production in the samples was analysed by gas chromatography (GC) after incubation for 1, 2, 4, and 8 days at 28° C. as static cultures. Also OD₆₀₀ and cell number in the samples were tested. Every samples were prepared in triplicate.

The ethylene production from the single Gd culture and mixed Gd+Ts cultures grown in SP and MP media were measured by gas chromatography (GC). No acetylene reduction was detected in samples grown in MP along all the experiment; neither in SP before 4 days of incubation, even in the single cultures. After 4 and 8 days of incubation ethylene production was detected in samples in medium SP, in single and mixed cultures.

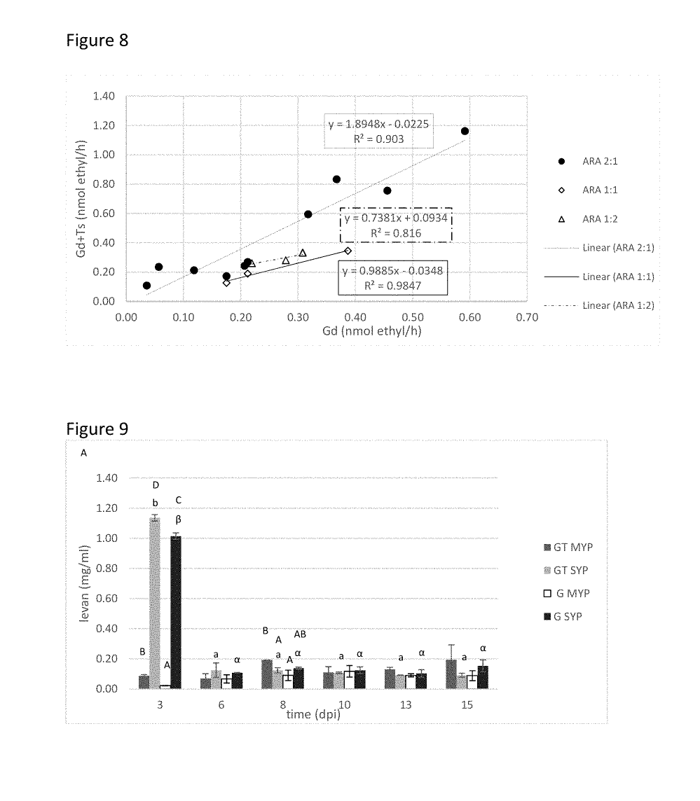

The peak of ethylene production measured by GC showed a high variation, but there was a constant correlation between the values, as is showed in FIG. 8. The ethylene production for mixed samples when the relation Gd:Ts was 2:1 was almost double than for single cultures. The correlation between both types of samples changes when the proportion between strains change, being 25% lower for mixed cultures when Ts is in higher concentration than Gd (1:2), than for single cultures. When Gd and Ts are mixed in the same proportion there is no variation in the ethylene production in regard with Gd single culture. These results show that the presence of Ts is able to modify the activity of the enzyme nitrogenase, and that this effect is related to the relative proportions of Gd and Ts.

### EXAMPLE 5

### Effects of Ts on Levan Production by Gd

Flasks with 100 ml of MYP and SYP were inoculated with 1 ml Gd+1 ml Ts of overnight cultures of both strains with OD₆₀₀ ˜0.2 and incubated for 14 days. Samples were collected every two days and 1 ml of each culture was stored in duplicate at −20° C. prior to analysis for levan production. OD₆₀₀ was measured and serial dilutions plated onto ATGUS and Marine Agar to estimate the cell number for both strains at the sampling times. Single cultures of Gd in MYP and SYP were inoculated and incubated in the same conditions as a control. To extract and quantify levan in the samples, samples were precipitated with 3 volumes of methanol and placed into a heat block set to 60° C. until dried and volume was reduced to approximately 1 ml. The precipitates were dissolved in 1 ml of H₂O. Acid hydrolysis was carried out by adding 0.01M H₂SO₄ and incubating 1 h at 121° C. After the incubation, 500 μl of DNSA reagent (100 ml aqueous solution contains 1 g 3,5-dinitrosalicylic acid, 0.4M NaOH and 30 g K—Na tartrate tetrahydrate) was added and mixed. Tubes were placed into boiling water for 15 minutes and 500 μl of 40% (w/v) K—Na tartrate was added and mixed. The absorbance of the samples was measured at 540 nm and the glucose concentration was estimated using a calibration line from a range of glucose standards.

The results are shown in FIG. 9. The levan production was higher for cultures in SYP than in MYP in the first days. The levan production along time in samples grown in MYP did not show significant differences, while there are statistical significant differences in samples grown in SYP. If the values are compared in relation to the sampling times, there are significant differences between the four samples 3 days post-inoculation and after 8 days of incubation.

### EXAMPLE 6

### Expression of Nitrogenase and Levansucrose Genes

Since differences in the nitrogenase activity were detected between samples of single Gd cultures and mixed cultures Gd+Ts grown in SP after 8 days of incubation, RNA was extracted from these samples and gene expression was assessed by qPCR. With real-time PCR or qPCR, the applicants investigated whether there were any differences on the enzymes nitrogenase and levansucrose genetic expression under different culture conditions.

Samples were prepared as described before in Example 4. After adjusting the OD₆₀₀ to 1, 5 ml of Gd for single cultures, and 5 ml Gd+5 ml Ts for mixed cultures, a final volume of 50 ml of MP and SP were inoculated and incubated at 28° C. as static cultures. After 8 days of incubation, 1 ml of samples was stored and RNA was extracted for qPCR. The RNA was isolated with Trizol® according to the manufacturer's protocol. RNA purity and integrity appropriate for downstream RT-qPCR applications were confirmed by measuring the ratio of absorbance at 260 nm/280 nm and 260 nm/230 nm. DNase digestion of samples was carried out using DNase I kit (Sigma) according to the manufacturer's instructions, to ensure that no DNA was present in the samples. First-strand cDNA synthesis was carried out using the Superscript™ III Reverse Transcriptase kit (Invitrogen) performed according to the manufacturer's manual. Reverse transcription reactions were carried out with 1 μg of RNA. The cDNA was diluted 1:5 and then used in RT-qPCR.

qPCR.

RT-qPCR was performed on the CFX96™ Real-Time System (BioRad) using the iTap™ Universal SYBR® Green Supermix (BioRad). The primers were used at 3.75 μM and 10 ng of cDNA per reaction. Thermocycling was performed as follows: 2 min at 95° C., 40 cycles of 5 sec at 95° C. and 15 sec at 60° C. The melt curve was performed to check the liability of the primers as follow: increment of 0.5° C. every 5 sec, from 60° C. to 95° C. All RT-qPCR assays were carried out using three technical replicates and non-template control. Primers to 23S were used to amplify reference genes (Galisa, et al., J. Microbiol Methods (2012) October; 91(1):1-7) and primers for nifH (forward: 5′-TCGACGACCTCCCAGAATAC-3′(SEQ ID NO 5); reverse: 5′-CCTTGTAGCCGATCTTCAGC-3′) (SEQ ID NO 6) and lsdA (forward: 5′-ACGCCGATCAGTTCAAGCTAT-3′ (SEQ ID NO 7); reverse: 5′-CCTGGTTCGTGTAGGTCTGG-3′) (SEQ ID NO 8) genes were used to target genes for the enzymes nitrogenase and levansucrose respectively. All primers' amplification efficiency was tested, and the efficiency value, calculated in relation to the slope got from the standard curve generated from serial dilutions of the template. Amplification efficiency was calculated as a percentage of template that was amplified in each cycle (% Efficiency=(E−1)*100; E=10^{-1/slope}). % E in the range 90%-105% indicate high amplification efficiency.

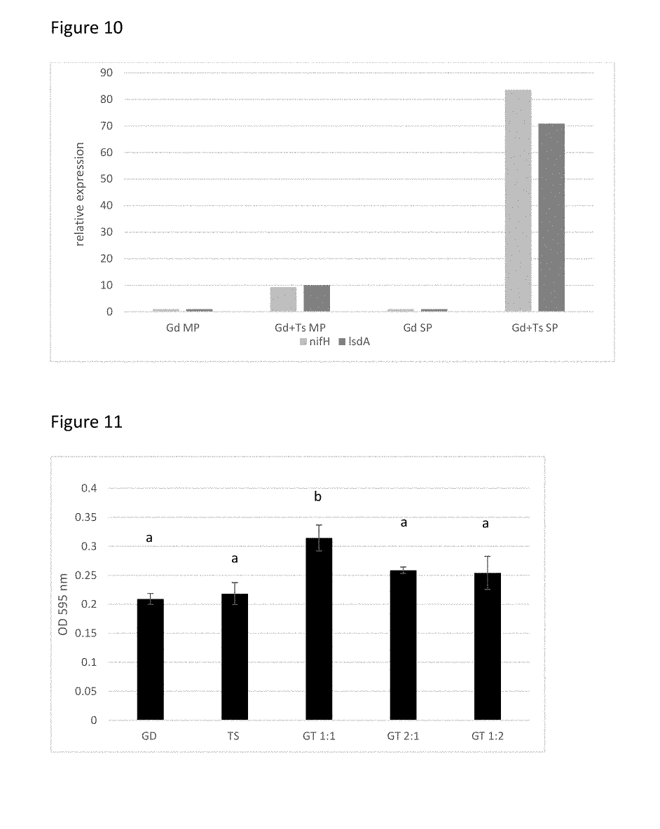

The results of this experiment are shown in FIG. 10. It appears that there is a trend for an increase in genetic expression of nifH and lsdA in mixed cultures, as compared to single Gd cultures, especially in samples grown in SP.

The study of nitrogenase and levansucrose genes expression by qPCR shows a trend to increase the expression for the two enzymes. These qPCR experiments show an effect of the presence of Ts in nitrogenase expression, which seems to increase as a response to the conditions generated by a mixed culture of Gd plus Ts especially in SP, but also in MP to some extent.

The levansucrose gene similarly shows a tendency to increase its expression in the presence of this second microorganism, which could be related with nitrogen fixation, since it appears that there is a correlation between nitrogen fixation and levan production, probably due to the protected environment created by levans to nitrogenase, avoiding oxygen diffusion, which could inhibit the enzyme activity. It has been demonstrated that the mucilaginous matrix produced by Gd is used by the bacteria to keep an anaerobic environment (Dong, et al., Applied Environmental Microbiology, 2002, pp 1754-1759). Since levan is the major exopolysaccharide secreted by Gd, it could be involved in the nitrogenase protection from oxygen besides in tolerance to other abiotic stresses such as NaCl, sucrose and desiccation (Velazquez-Hernandez, et al., Archives of Microbiology 2011 vol 193, 139-149).

### EXAMPLE 7

### Effect of Ts on Adherence of Gd

Assessment of the adhesion capacity of the mixed culture Gd+Ts in comparison with Gd single culture was carried out by measuring the ability of cultures to attach to artificial surface (centrifuge tubes), as described (Favre-Bonté et al. Biomed. Central Microbiology (2007) 7 (33) ppl-12). Starter cultures of Gd and Ts were prepared in SYP (da Silva-Froufe, et al., 2009 supra.) and SYP modified with Herbst's artificial seawater (An, et al., 2007 supra.), respectively. After 48 hours growing at 28° C. at 150 rpm, cultures were washed twice with PBS (4000 rpm, 15 minutes), and the pellets were re-suspended with PBS at OD₆₀₀ 1 and 0.5. The samples were prepared by inoculation of 1 ml of Gd or Ts, for single cultures, and 1 ml Gd+1 ml Ts for mixed samples, in a final volume of 10 ml of SYP in the following proportions Gd:Ts (taking as reference the OD₆₀₀ of the cultures): 1:1, 2:1 and 1:2. Five repetition per treatment were prepared by distributing 1.5 ml of samples in 15 ml centrifuge tubes, and incubated as static culture at 28° C., during 8 days.

To check the adherence of the cells to the surface, the medium was removed, the tubes were washed 3 times with 1.5 ml of PBS, and cells were fixed with 10 ml of methanol for 15 minutes. The alcohol was removed and the tubes were air dried. The biofilm formed was stained with crystal violet 0.1% w/v for 5 minutes. The dye was rinsed with distilled water and air dried. Later, the dye was re-suspended with 10 ml of glacial acetic acid 33%. The absorbance of the samples was measured at 595 nm. As control, 5 tubes with 1.5 ml of SYP were incubated and treated in the same way. The value from the blank was taken as background and it was subtracted from the values obtained for the rest of the samples.

The results are shown in FIG. 11. This experiment shows a tendency of the cell cultures to attach to an artificial surface, which could be an indication of the ability of Gd to form biofilm in different conditions. Formation of biofilm would be expected to impact on plant colonization properties. This ability appears to be enhanced by the combination of Ts as a mixed culture, in particular in a ratio of 1:1.

### EXAMPLE 8

### Attachment and Seed Germination

Oilseed rape (OSR) seeds were sterilized by soaking them in 100% ethanol, vortexing and allowing them to stand for 2 minutes, after which they were thoroughly washed and vortexed with sterile de-ionised water (SDW) three times. After that, seeds were soaked in 70% (v/v) bleach with 1% (v/v) Tween 80, vortexed and allowed to stand for 30 minutes. After that they were again thoroughly washed and vortexed with SDW at least more five times.

To prepare the inoculum, fresh cultures of Gd and Ts were incubated for 24 hours in optimal media. OD was adjusted to 0.35 for Gd (˜10⁸ cfu/ml) and to 0.2 and 0.1 for Ts (˜10⁸ cfu/ml and ˜10⁶ cfu/ml respectively). Cultures were diluted in an aqueous composition comprising 3% (v/v) sucrose, 0.1% (v/v) Tween80 and 0.3% (v/v) gum Arabic. The treatments were as follow: a) control, just water; b) Gd, ˜2.5·10⁵ cfu/ml; c) Ts, ˜2.5·10⁵ cfu/ml; d) Gd+Ts 1:1, both strains at ˜2.5·10⁵ cfu/ml; e) Gd+Ts 2:1, Gd ˜2.5·10⁵ cfu/ml and Ts ˜2.5·10³ cfu/ml. The actual inoculum concentrations were as follows:

| TREATMENT | Gd (cfu/ml) | Ts (cfu/ml) |
|---|---|---|
| Gd | 3.75 · 10⁵ | |
| Ts | | 2.45 · 10⁵ |
| Gd + Ts 1:1 | 4.90 · 10⁵ | 2.15 · 10⁵ |
| Gd + Ts 2:1 | 3.3 · 10⁵ | 6.52 · 10⁴ |
| Control | — | — |

The sterilized seeds were soaked in the different treatments for 30 minutes.

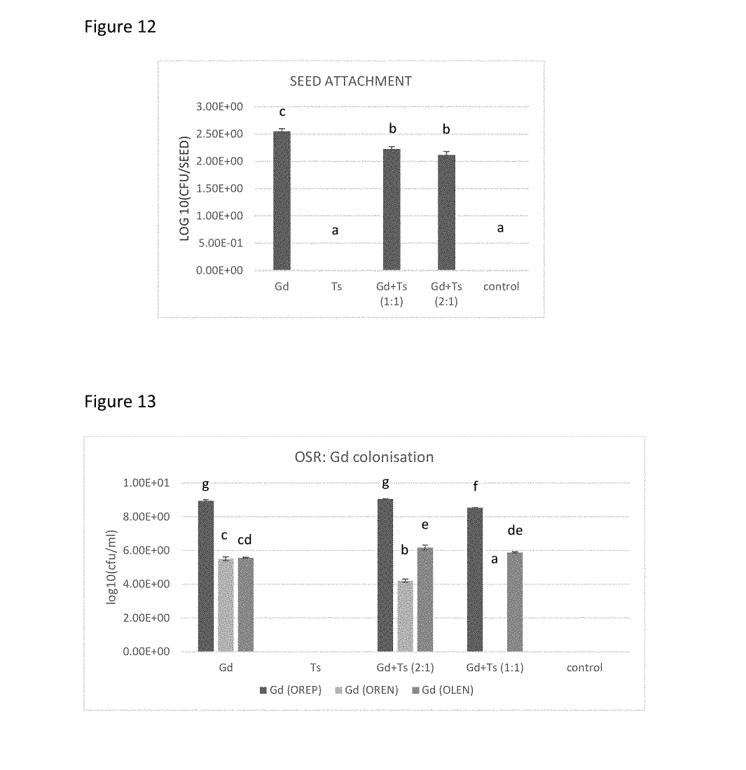

After the treatment of the seeds, the solution was discarded and seeds were placed onto an inverted Petri dish with a glass fibre paper moistened with 3 ml of SDW. Plates were protected from light by covering with aluminium foil and incubated at 21° C. To test the attachment of the bacteria to the seeds, three groups of 20 seeds per treatment, were washed in 5 ml of PBS and shaken vigorously at 20° C. for 2 hours. The solution obtained was serially diluted and plated onto LGIP and Marine Agar media. Plates were then incubated for 4 days at 28° C. The number of cells recovered from the surface of the seeds were counted and the results are shown in FIG. 12.

After 24 hours of incubation, germinated seeds were counted to calculate germination rate and placed in conical tubes with 5 ml with Murashige and Skoog (MS) basal medium (Sigma M0404). Plants were incubated in a plant growth chamber (cycle: 12 hours of dark at 15° C. and 60% RH/12 hours of light at 28° C. and 60% RH) at least until two true leaves had grown. 15 plants per treatment were incubated.

The results show that the attachment of Gd and Ts to the seeds showed differences for the different treatments. It was not possible to re-isolate Ts from the seeds, despite that this strain was detected in plant extracts, suggesting that this becomes well adhered to the seed surface. The mixed cultures show reduced recovery and so enhanced adherence as compared to the single Gd culture.

After inoculation and germination of the seeds, the germinated seedlings were incubated in the plant growth chamber for a further 15 days. Seven seedlings from each treatment were processed to get extracts from the roots and the leaves, after sterilization of the surface.

For the re-isolation of the epiphytic microorganisms from the root surface, the procedure was similar to that used for seed attachment assay. In particular, roots were also washed in an isotonic buffer to re-isolate the epiphytic microorganisms colonizing the surface of the roots.

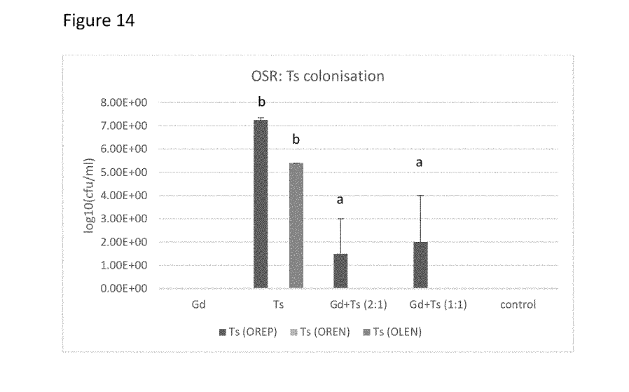

For endophytic colonisation, roots and leaves surface were sterilized by immersion for 10 minutes in 10% (v/v) bleach, pH adjusted to 8.0, plants were rinsed with SDW and macerated in 1 ml of PBS (O'Callagham, et al., Applied and Environmental Microbiology, 2000, 66(5) 2185-2191). The plant extract was serial diluted and plated in duplicate onto LGIP and Marine Agar. The results are shown in FIGS. 13 and 14 respectively.

Uninoculated plants did not show contamination, and no cross contamination between the different treatments was found. Except in plants inoculated just with Ts, it was not possible to recover Ts in endophytic association with the plant, but this bacterium was found on the surface of the roots. Nevertheless Ts colonized the root in lower number when it was inoculated in association with Gd (FIG. 14).

The recovery of Gd showed important differences between the treatments (FIG. 13). While in the plants inoculated with a single culture of Gd there were essentially no differences in the number of re-isolated microorganisms as endophytes between roots and leaves, the distribution of Gd inside the plant changed in the different parts of the plant (roots versus leaves) when they were inoculated with the mixed cultures, and also with respect to those plants inoculated just with Gd. Plants inoculated with Gd+Ts, in a proportion 2:1 showed improved endophytic colonization, despite the fact that the colonisation on the surface of the plant was the same than with the single inoculation. Furthermore, it seemed that the treatment with the combined inoculum affected the migration of the bacteria inside the plant, favouring localisation to the leaves. The number of isolated from inside of the aerial part of the plant was ten-fold higher for plants inoculated with the mixed culture in regard with the plants inoculated with pure culture of Gd.

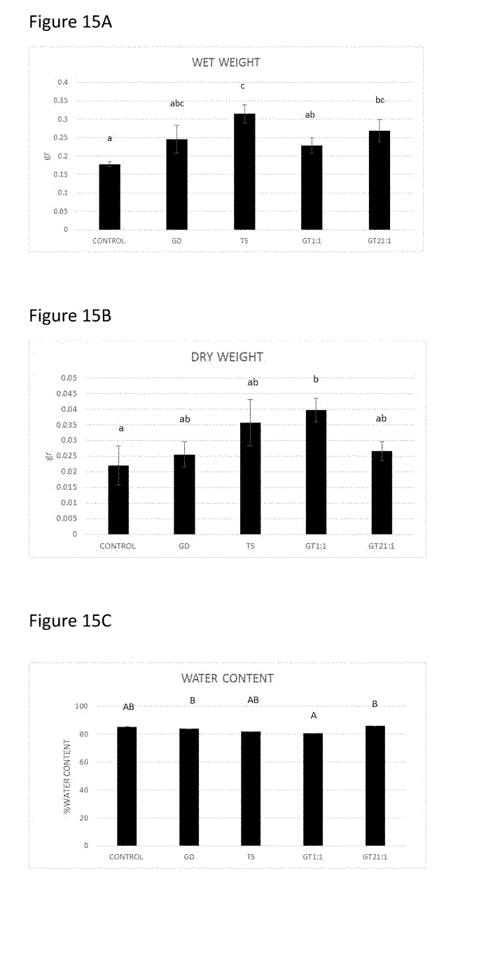

In addition, once plants were sufficiently grown, some were taken out from the tubes, and wet and dried weights were measured. The results are shown in FIGS. 15A,B.

The measure of the plant parameters do not show differences between the diverse treatments with Gd in terms of the LSD, but it shows a tendency of the plants treated with Gd+Ts (1:1) to a higher dry weight (DW), and there is a significant difference between the DW of this mixed treatment on regard with the control plants, which shows a tendency of the plants treated with Gd+Ts in a mixture of 1:1 to increase the biomass, despite the wet weight (FIGS. 15A-C).

### EXAMPLE 9

### Levan Production and Quantification

Flasks with 100 ml of SYP were inoculated with 1 ml Gd+1 ml Ts of overnight cultures of both strains with OD₆₀₀ ˜0.2 and incubated during 3 days. Samples were collected every day for 3 days and triplicate 1 ml aliquots of each culture was stored at −20° C. to analyse the levan production. OD₆₀₀ was measured and serial dilutions plated on ATGUS and Marine Agar to get the cfu for both strains. Single cultures of Gd and Ts in SYP were inoculated and incubated in the same conditions as control.

To extract and quantify levan in the samples, the cultures were firstly centrifuged (10,000 rpm, 20 min, 4° C.) and the supernatants were decanted and placed into new tubes. Samples were precipitated as described in Example 5, with 3 volumes of methanol and placed into a heat block (Thermomixer) set to 60° C. until dried and volume was reduced to approximately 1 ml. The precipitates were dissolved in 1 ml of water. Acid hydrolysis was carried out adding 0.2% of H₂SO₄ 5 M and incubating for 1 hour at 121° C. After the incubation, 500 μl of DNSA reagent (in 100 ml, 1 g 3,5-dinitrosalicylic acid dissolved in 50 ml of H2O, 20 ml NaOH 2M, 30 g K—Na tartrate tetrahydrate) was added and mixed. Tubes were placed into boiling water for 15 min and 500 μl of 40% K—Na tartrate was added and mixed. The absorbance of the samples was measured at 540 nm and the glucose concentration was estimated using a calibration line from a range of glucose standards.

Levan from Ts was also quantified since recent research showed the presence of levansucrose and levanase enzymes for Terribacillus species (Lu, et al., Genome Announcements 2015 3 (2), pp e00126-15).

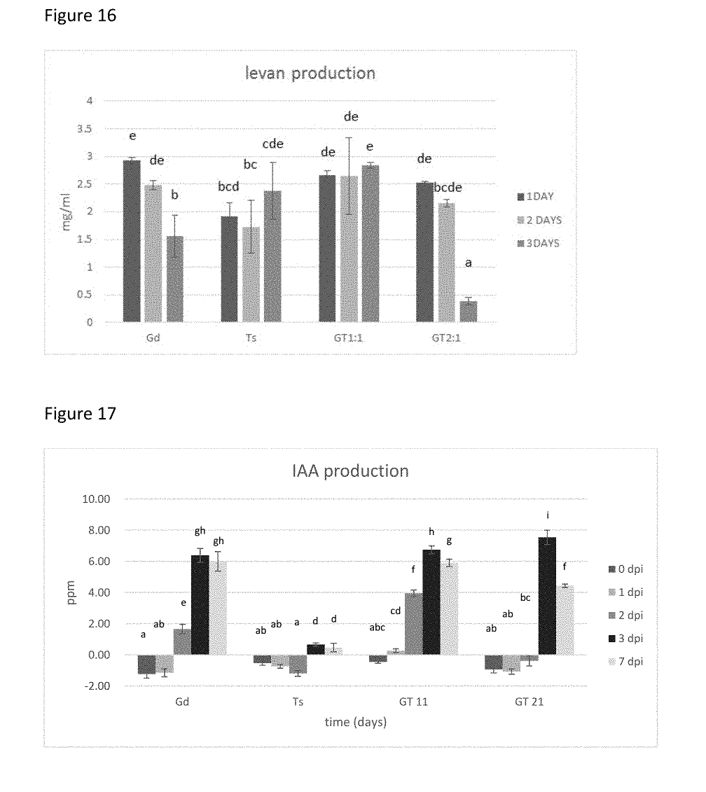

The results are shown in FIG. 16. While there were no significant differences in the levan concentration in the mixed culture in proportion 1:1, there was a large decrease in the quantification of levan detected in the medium when both strains were present with a higher concentration of Gd. In this case, the levan concentration in the medium was following a similar trend to that of the single Gd culture but with a more intense effect on the levan concentration. Without being bound by theory, this may be due to the consumption of sucrose and the degradation of levan by both strains.

### EXAMPLE 10

### Effect of Terribacillus on Production of Plant Hormone by Gd

To check the ability of Gd to produce the auxin IAA on its own or in the presence of Ts, cultures of Gd, Ts, Gd+Ts (1:1) and Gd+Ts (2:1) were prepared in SYP and incubated at 28° C., 150 rpm for one week. Samples (1 ml) of all the cultures were taken in triplicate daily during the first three days, and on the seventh day, of incubation. Samples were spun at 13000 rpm for 5 minutes and the supernatant recovered in glass tubes. The supernatants were mixed with 4 volumes of Salowski's reagent (150 ml of H₂SO₄ 96%, 250 ml of H₂O and 7.5 ml of FeCl₃ 0.5 M) per volume of sample. Development of a pink colour indicated IAA production.

OD₅₃₅ was read using a spectrophotometer. The concentration of IAA was estimated by a standard IAA graph. The final value was calculated as the average of the three replicate for every samples, and the error was calculated with the standard error.

The results are shown in FIG. 17. It was clear that whilst Ts did not produce IAA to any significant extent, in the presence of Ts, the production of IAA by Gd increased overall, suggesting that the Ts was modifying the behaviour of Gd.

1. A method for introducing a plant growth mediating entity or substance into plants, said method comprising administering said plant growth mediating entity or substance to a plant in combination with a strain of Terribacillus.

2. The method of claim 1 wherein the strain of Terribacillus is a Terribacillus saccharophilus.

3. The method of claim 1 wherein the strain of Terribacillus saccharophilus comprises any one of SEQ ID NOs 1-4.

4. The method of claim 1 wherein the plant growth mediating entity or substance is a nitrogen-fixing bacteria.

5. The method of claim 4 wherein the nitrogen-fixing bacteria is a bacteria which forms a levan coat.

6. The method of claim 4 or claim 5 wherein the nitrogen fixing bacteria is Gluconacetobacter diazotrophicus (Gd).

7. The method of claim 6 wherein the Terribacillus is intimately associated with the Gd prior to administration.

8. The method of claim 1 wherein a combination of Terribacillus and a plant growth mediating entity or substance is administered to a growing plant.

9. The method of claim 8 wherein the plant is subjected to a wounding process prior to administration of said combination.

10. The method of claim 1 wherein a combination of Terribacillus and nitrogen-fixing bacteria is administered to a seed.

11. An agricultural composition comprising a strain of Terribacillus.

12. The agricultural composition of claim 11 which further comprises a nitrogen-fixing bacteria.

13. The agricultural composition of claim 12 wherein the nitrogen fixing bacteria is Gluconacetobacter diazotrophicus (Gd).

14. The agricultural composition of claim 11 wherein the strain of Terribacillus is a Terribacillus saccharophilus, Terribacillus halophilus, Terribacillus goriensis or Terribacillus aidingensis.

15. The agricultural composition of claim 13 wherein the strain of Terribacillus saccharophilus comprises any one of SEQ ID NOS 1-4.

16-26. (canceled)

27. A plant or seed which is colonised by Terribacillus.

28. The plant or seed of claim 27 which is a progeny of a plant or seed which is colonized by Terribacillus.

29. The plant or seed of claim 28 which further comprises a nitrogen fixing bacteria.

30. The plant or seed of claim 29 wherein the nitrogen fixing bacteria is Gluconacetobacter diazotrophicus (Gd).

31. The agricultural composition of claim 12 which is obtained by co-culturing a strain of Terribacillus and a strain of nitrogen fixing bacteria together in a medium which supports the growth of both strains.
